(19) United States
(12) Patent Application Publication
(10) Pub. No.: US 2019/0040812 A1
(43) Pub. Date: Feb. 7, 2019

(54) METHOD OF DIAGNOSING A HIGH PRESSURE FUEL DELIVERY SYSTEM

(71) Applicant: GM GLOBAL TECHNOLOGY OPERATIONS LLC, Detroit, MI (US)

(72) Inventors: Azeem Sarwar, Rochester Hills, MI (US); Xiangxing Lu, Sterling Heights, MI (US); Rafat F. Hattar, Royal Oak, MI (US)

(73) Assignee: GM GLOBAL TECHNOLOGY OPERATIONS LLC, Detroit, MI (US)

(21) Appl. No.: 15/668,755

(22) Filed: Aug. 4, 2017

(51) Int. Cl. F02D 41/22; F02D 41/26

(52) U.S. Cl. CPC F02D 41/22; F02D 2200/0602; F02D 2041/225; F02D 41/26

(57) ABSTRACT

A method of diagnosing a high pressure fuel delivery system includes sensing an after shutdown fuel pressure in the fuel rail. An after shutdown leak rate is calculated from the after shutdown fuel pressure, and compared to a shutdown leak threshold. The high pressure fuel delivery system is analyzed to detect a leak in one of the fuel rail or the fuel injector when the after shutdown leak rate is greater than the shutdown leak threshold. A cranking fuel pressure in the fuel rail is also sensed. A cranking leak rate is calculated from the cranking fuel pressure, and compared to a cranking leak threshold. The high pressure fuel delivery system is analyzed to detect a leak in the high pressure fuel pump when the cranking leak rate is greater than the cranking leak threshold.

### INTRODUCTION

The disclosure generally relates to a method of diagnosing a high pressure fuel delivery system for an internal combustion engine.

Many internal combustion engines use a high pressure fuel delivery system to inject fuel into one or more combustion chambers of the engine. The high pressure fuel delivery system may include a high pressure fuel pump, which supplies pressurized fuel to a fuel rail. One or more fuel injectors are connected to the fuel rail in fluid communication. When signaled by a vehicle controller, the fuel injector opens, and a burst of fuel is injected into the combustion chamber. The amount of fuel that is injected into the combustion chamber is dependent upon the fuel pressure within the fuel rail, as well as the time for which the fuel injector remains open. A leak from any of the high pressure fuel pump, the fuel rail, or the fuel injector may reduce the pressure within the fuel rail to a level that significantly affects operation of the engine.

### SUMMARY

A method of diagnosing a high pressure fuel delivery system of an internal combustion engine is provided. The high pressure fuel delivery system includes a high pressure pump, a fuel rail, and a fuel injector. The method includes sensing an after shutdown fuel pressure in the fuel rail with a fuel pressure sensor. The after shutdown fuel pressure is sensed over a shutdown period of time, when a rotational speed of the internal combustion engine is approximately equal to zero. An after shutdown leak rate of the high pressure fuel delivery system is calculated with a processing unit. The after shutdown leak rate is calculated from the after shutdown fuel pressure sensed over the shutdown period of time. The processing unit compares the after shutdown leak rate to a shutdown leak threshold, to determine if the after shutdown leak rate is greater than the shutdown leak threshold, or if the after shutdown leak rate is equal to or less than the shutdown leak threshold. The processing unit analyzes the high pressure fuel delivery system to detect a leak in one of the fuel rail or the fuel injector, when the after shutdown leak rate is greater than the shutdown leak threshold. A cranking fuel pressure in the fuel rail is also sensed with the fuel pressure sensor. The cranking fuel pressure is sensed over a cranking period of time while the internal combustion engine is cranking and not firing. The processing unit calculates a cranking leak rate of the high pressure fuel delivery system from the cranking fuel pressure sensed over the cranking period of time, and compares the cranking leak rate to a cranking leak threshold to determine if the cranking leak rate is greater than the cranking leak threshold, or if the cranking leak rate is equal to or less than the cranking leak threshold. The processing unit analyzes the high pressure fuel delivery system to detect a leak in the high pressure fuel pump, when the cranking leak rate is greater than the cranking leak threshold.

In one aspect of the method, analyzing the high pressure fuel delivery system to detect a leak in one of the fuel rail or the fuel injector includes comparing a long term multiplier for the fuel injector control to a multiplier threshold. The long term multiplier for the fuel injector is compared to the multiplier threshold to determine if the long term multiplier for the fuel injector is greater than the multiplier threshold, or if the long term multiplier is equal to or less than the multiplier threshold. The processing unit may identify a leak in the fuel rail when the long term multiplier for the fuel injector is greater than the multiplier threshold. The processing unit may identify a leak in the fuel injector when the long term multiplier for the fuel injector is equal to or less than the multiplier threshold.

In another aspect of the method, the processing unit may calculate a rail/injector leak severity from the after shutdown leak rate, when a leak from one of the fuel rail or the fuel injector is identified. The processing unit may issue a notification when the rail/injector leak severity is greater than a pre-defined rail/injector limit, thereby enabling a service technician to address the identified leak before the leak becomes so severe that it affects operation of the internal combustion engine.

In another aspect of the method, the after shutdown fuel pressure sensed over the shutdown period of time may be normalized based on a fuel temperature in the fuel rail during the shutdown period of time. Similarly, the cranking fuel pressure sensed over the cranking period of time may also be normalized based on the fuel temperature in the fuel rail during the cranking period of time.

In another aspect of the method, analyzing the high pressure fuel delivery system to detect a leak in the high pressure fuel pump may include determining if one of the fuel rail or the fuel injector is leaking, or if both the fuel rail and the fuel injector are not leaking. The processing unit may identify a leak in the high pressure fuel pump when both the fuel rail and the fuel injector are not leaking, and the cranking leak rate is greater than the cranking leak threshold.

In another aspect of the method, analyzing the high pressure fuel delivery system to detect a leak in the high pressure fuel pump may include comparing the cranking leak rate to the after shutdown leak rate. The processing unit compares the cranking leak rate to the after shutdown leak rate to determine if the cranking leak rate is equal to the after shutdown leak rate, if the cranking leak rate is less than the after shutdown leak rate, or if the cranking leak rate is greater than the after shutdown leak rate. The processing unit may issue a notification that the high pressure oil pump is not leaking, when the cranking leak rate is equal to the after shutdown leak rate. The processing unit may identify a leak in the high pressure fuel pump when the cranking leak rate is greater than the after shutdown leak rate. The processing unit may identify an unknown failure mode when the cranking leak rate is less than the after shutdown leak rate.

In another aspect of the method, the processing unit may calculate a pump leak severity from the cranking leak rate, when a leak from the high pressure fuel pump is identified. The processing unit may issue a notification when the pump leak severity is greater than a pre-defined pump limit, thereby enabling a service technician to address the identified leak before the leak becomes so severe that it affects operation of the internal combustion engine.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a high pressure fuel delivery system.

FIG. 2 is a flowchart representing a method of diagnosing the high pressure fuel delivery system.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

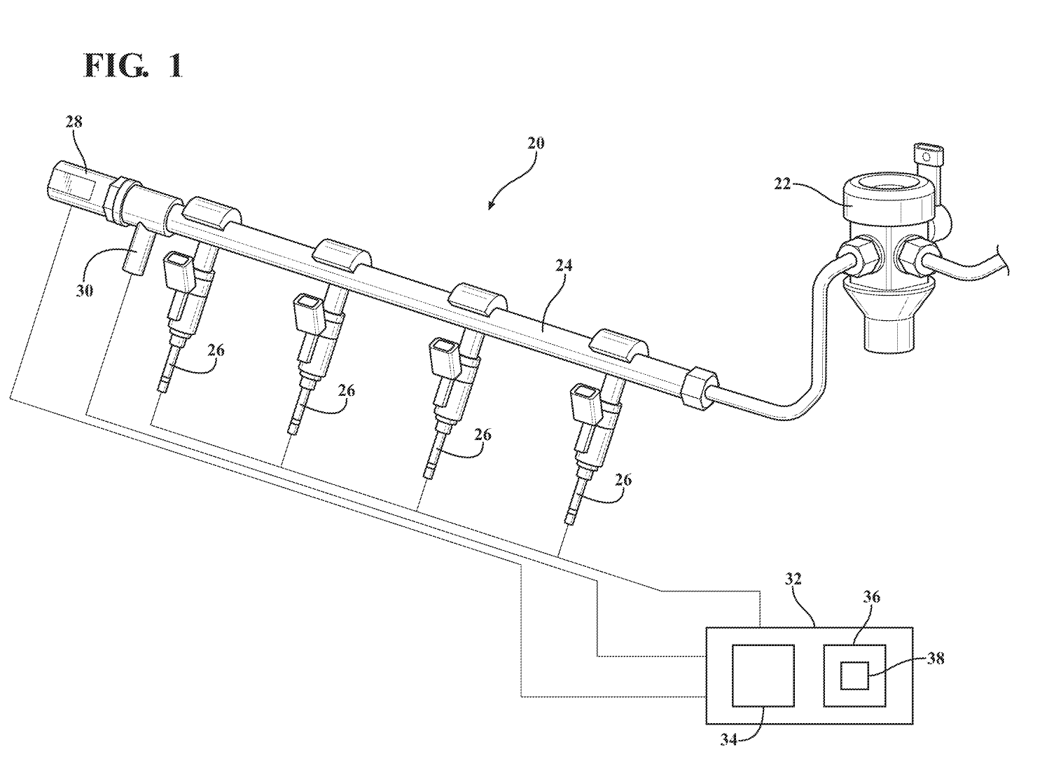

Referring to the FIGS., wherein like numerals indicate like parts throughout the several views, a high pressure fuel delivery system is generally shown at 20 in FIG. 1. The high pressure fuel delivery system 20 may be used to provide fuel to a combustion chamber of an internal combustion engine. The fuel may include a combustible fuel, such as but not limited to gasoline or diesel fuel. The high pressure fuel delivery system 20 includes, but is not limited to, a high pressure fuel pump 22, a fuel rail 24, and at least one fuel injector 26. The exemplary embodiment of the high pressure fuel delivery system 20 shown in FIG. 1 includes four fuel injectors 26. However, it should be appreciated that the number of fuel injectors 26 is not limited to the four shown in the exemplary embodiment, and that the high pressure fuel delivery system 20 may include one, two, three, four, or more fuel injectors 26.

The specific construction and operation of the high pressure fuel delivery system 20 are not pertinent to the teachings of this disclosure, and are therefore not described in detail herein. However, generally, the high pressure fuel pump 22 is operable to pressurize fuel disposed within the fuel rail 24. The high pressure fuel pump 22 may include a style and/or configuration of pump that is capable of pressurizing fuel for injection into a combustion chamber of the internal combustion engine. The fuel rail 24 receives the pressurized fuel from the high pressure fuel pump 22, and supplies the pressurized fuel to the fuel injectors 26. The fuel injectors 26 are controlled to inject a pulse of pressurized fuel into the combustion chamber of the internal combustion engine. In order to start the internal combustion engine, the high pressure fuel pump 22 is engaged, while the engine is cranking, i.e., rotating, in order to build or increase the fuel pressure within the fuel rail 24 to an initial injection pressure for engine operation. While the high pressure fuel pump 22 is engaged to increase the fuel pressure, the engine is cranking without firing, i.e., without the fuel being injected into the combustion chamber for ignition. Upon the fuel pressure reaching the initial injection pressure, an engine controller signals the fuel injectors 26 to inject the pressurized fuel into the combustion chambers for ignition, whereby the fuel may ignite and the internal combustion engine may begin to ignite, i.e., run. When the internal combustion engine is turned off, both the high pressure fuel pump 22 and the fuel injectors 26 stop operation.

The high pressure fuel delivery system 20 may further include a pressure sensor 28 and a temperature sensor 30. The pressure sensor 28 may include a device that is capable of sensing or otherwise determining a fluid pressure of the fuel disposed within the fuel rail 24. The temperature sensor 30 may include a device that is capable of sensing or otherwise determining a temperature of the fuel disposed within the fuel rail 24. The pressure sensor 28 and the temperature sensor 30 sense data related to the pressure and temperature of the fuel within the fuel rail 24, and communicate that data to a processing unit 32.

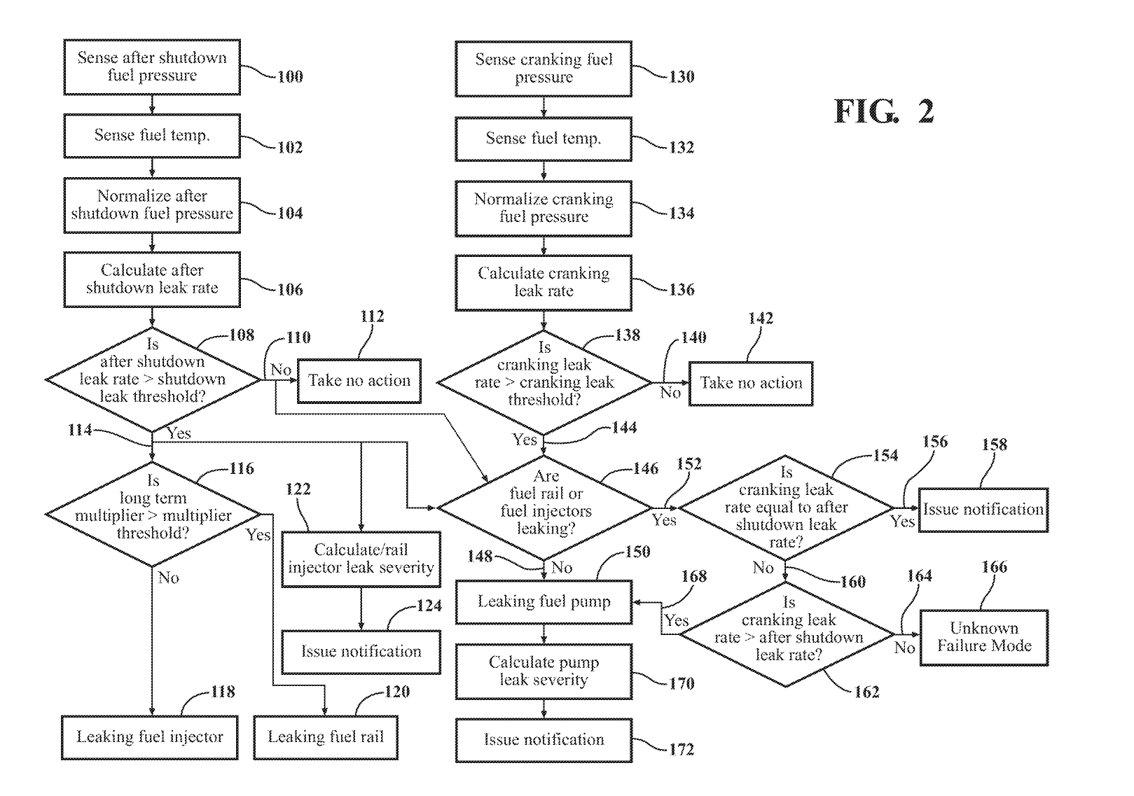

The processing unit 32 is operable to diagnose the operation of the internal combustion engine, including but not limited to the high pressure fuel pump 22, the fuel rail 24, and the fuel injectors 26. The processing unit 32 may be referred to generically as a controller, a computer, a module, etc. In some embodiments, the processing unit 32 may be referred to as an engine control module, an engine control unit, an engine controller, a diagnostic controller, a diagnostic computer, etc. In some embodiments, the processing unit 32 may be located onboard the high pressure fuel delivery system 20 and/or internal combustion engine. In other embodiments, the processing unit 32 is located remotely from the high pressure fuel delivery system 20, and the required data is transmitted from the high pressure fuel delivery system 20 to the processing unit 32 wirelessly. The processing unit 32 may include a computer and/or processor 34, and include software, hardware, memory, algorithms, connections, sensors, etc., to manage and control the operation of the internal combustion engine. As such, a method, described below and generally shown in FIG. 2, may be embodied as a program or algorithm operable on the processing unit 32. It should be appreciated that the processing unit 32 may include a device capable of analyzing data from various sensors, comparing data, making the decisions required to control the operation of the internal combustion engine and/or the high pressure fuel delivery system 20, and executing the required tasks to control the operation of the internal combustion engine and/or the high pressure fuel delivery system 20.

The processing unit 32 may be embodied as one or multiple digital computers or host machines each having one or more processors 34, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and a required input/output (I/O) circuitry, I/O devices, and communication interfaces, as well as signal conditioning and buffer electronics.

The computer-readable memory may include a non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or other optical medium, as well as other possible memory devices such as flash memory.

The processing unit 32 includes tangible, non-transitory memory 36 on which are recorded computer-executable instructions, including a fuel delivery system diagnostic algorithm 38. The processor 34 of the controller is configured for executing the fuel delivery system diagnostic algorithm 38. The fuel delivery system diagnostic algorithm 38 implements a method of diagnosing the high pressure fuel delivery system 20.

The method of diagnosing the high pressure fuel delivery system 20 includes sensing an after shutdown fuel pressure in the fuel rail 24 with the fuel pressure sensor 28. The step of sensing the after shutdown fuel pressure is generally indicated by box 100 in FIG. 2. The after shutdown fuel pressure is sensed over a shutdown period of time when a rotational speed the internal combustion engine is approximately equal to zero. It should be appreciated that “approximately equal to zero” includes a rotational speed of zero, or a rotational speed slightly higher than zero yet slow enough so as to not significantly affect the process described herein, such as but not limited to a rotational speed of less than 25 rpm. The duration of the shutdown period of time may vary. However, the processing unit 32 measures the duration of the shutdown period of time and saves this value in the memory 36 of the controller. The after shutdown fuel pressure is the fluid pressure of the fuel disposed within the fuel rail 24 during the period of time immediately after the internal combustion engine is stopped. The high pressure fuel delivery system 20 is intended to be closed system when the engine is stopped. Accordingly, no fuel should leak from the components of the high pressure fuel delivery system 20, and the fuel pressure within the fuel rail 24 should remain constant. However, immediately after the internal combustion engine has stopped moving, the fuel within the fuel rail 24 may absorb heat from the internal combustion engine, thereby increasing the temperature of the fuel within the fuel rail 24. As the temperature of the fuel within the fuel rail 24 increases, the fuel pressure within the fuel rail 24 will also increase a determinable amount due to thermal expansion. Barring leakage or fuel loss from the fuel rail 24, the fuel pressure increase within the fuel rail 24 due to thermal expansion of the fuel may be consistently and accurately calculated, and is referred to hereinafter as the nominal increase in fuel pressure due to thermal expansion. If the measured fuel pressure increase within the fuel rail 24 during the shutdown period of time varies from the nominal increase in fuel pressure due to thermal expansion, then it may be assumed that fuel is leaking from a component of the high pressure fuel delivery system 20.

In addition to the after shutdown fuel pressure, a fuel temperature of the fuel disposed within the fuel rail 24 is also sensed during the shutdown period of time. The step of sensing the fuel temperature during the shutdown period of time is generally indicated by box 102 in FIG. 2. The fuel temperature is sensed with the temperature sensor 30, and may be used by the processing unit 32 to normalize the after shutdown fuel pressure over the shutdown period of time. The step of normalizing the after shutdown fuel pressure is generally indicated by box 104 in FIG. 2. As noted above, the measured change in the fuel pressure during the shutdown period of time may be compared to the nominal fuel pressure increase due to thermal expansion. However, the actual temperature of the fuel within the fuel rail 24 may vary from the temperature at which the nominal fuel pressure increase due to thermal expansion was calculated. Normalizing the after shutdown fuel pressure over the shutdown period compensates for this variation in fuel temperatures. The after shutdown fuel pressure may be normalized for the current temperature of the fuel with in the fuel rail 24 using a suitable process.

The processing unit 32 calculates an after shutdown leak rate of the high pressure fuel delivery system 20 from the after shutdown fuel pressure sensed over the shutdown period of time. The step of calculating the after shutdown leak rate is generally indicated by box 106 in FIG. 2. The after shutdown leak rate is the amount or mass of fuel that leaks from the high pressure fuel delivery system 20 per unit time during the shutdown period of time. The mass of fuel that leaks from the high pressure fuel delivery system 20 during the shutdown period of time may be calculated from Equation 1 below.

$${m}_{leak} = \frac{{m}_{rail}}{B ( p , T )} ( ( {p}_{1} - {p}_{2} ) + Δ {p}_{temp} ) \qquad 1 )$$

Referring to Equation 1, mₗₑₐₖ is the mass of fuel that has leaked from the high pressure fuel delivery system 20 during the shutdown period of time, mᵣₐᵢₗ is the mass of fuel disposed within the fuel rail 24 at the beginning of the shutdown period of time, i.e., immediately after the engine stops moving, B(p,T) is the Bulk Modulus of Elasticity of the fuel, p₂ is the fuel pressure of the fuel within the fuel rail 24 at the end of the shutdown period of time, p₁ is the fuel pressure of the fuel within the fuel rail 24 at the beginning of the shutdown period of time, and Δpₜₑₘₚ is the nominal fuel pressure increase due to thermal expansion.

The nominal fuel pressure increase due to thermal expansion may be calculated in a suitable manner. For example, the nominal fuel pressure increase due to thermal expansion may be calculated from Equation 2 below.

$$Δ {p}_{temp} = KB ( 1 - \frac{1}{1 + β Δ T} ) \qquad 2 )$$

Referring to Equation 2, Δpₜₑₘₚ is the nominal fuel pressure increase due to thermal expansion, K is a system dependent calibratable coefficient, B is the Bulk Modulus of Elasticity of the fuel, β is the volumetric coefficient of expansion of the fuel, and ΔT is the change in temperature of the fuel within the fuel rail 24 during the shutdown period of time.

After the mass of fuel leaked from the high pressure fuel delivery system 20 during the shutdown period of time (mₗₑₐₖ) has been calculated, it may be divided by the shutdown period of time to calculate the after shutdown leak rate. As such, the after shutdown leak rate is provided by Equation 3 below.

$${Q}_{shutdown} = \frac{{m}_{leak}}{{t}_{shutdown}} \qquad 3 )$$

Referring to Equation 3, Q_{shutdown} is the after shutdown leak rate, mₗₑₐₖ is the mass of fuel that has leaked from the high pressure fuel delivery system 20 during the shutdown period of time, and tshutdown is the duration of the shutdown period of time.

Once the after shutdown leak rate has been calculated, the processing unit 32 compares the after shutdown leak rate to a shutdown leak threshold. The step of comparing the after shutdown leak rate to the shutdown leak threshold is generally indicated by box 108 in FIG. 2. The after shutdown leak rate is compared to the shutdown leak threshold to determine if the after shutdown leak rate is equal to or less than the shutdown leak threshold, or if the after shutdown leak rate is greater than the shutdown leak threshold. The shutdown leak threshold is value for a change in fuel pressure immediately after the engine has stopped moving that is indicative of a possible leak in the high pressure fuel delivery system 20. The shutdown leak threshold may be defined as the nominal fuel pressure increase due to thermal expansion, or a value slightly less than the nominal fuel pressure increase due to thermal expansion. By defining the shutdown leak threshold to include a small positive value, the method allows some variation in the system without indicating a possible leak from one of the components of the high pressure fuel delivery system 20.

When the processing unit 32 determines that the after shutdown leak rate is equal to or less than the shutdown leak threshold, generally indicated at 110 then no additional action is taken, generally indicated by box 112 in FIG. 2. When the processing unit 32 determines that the after shutdown leak rate is greater than the shutdown leak threshold, generally indicated at 114, then the processing unit 32 proceeds to analyze the high pressure fuel delivery system 20 to detect a leak in one of the fuel rail 24 or the fuel injector 26.

In order to analyze the high pressure fuel delivery system 20 to detect a leak in either the fuel rail 24 of one of the fuel injectors 26, the processing unit 32 may compare a long term multiplier for the fuel injectors 26 to a multiplier threshold to determine if the long term multiplier for the fuel injector 26 is greater than the multiplier threshold, or if the long term multiplier is equal to or less than the multiplier threshold. The step of comparing the long term multiplier to the multiplier threshold is generally indicated by box 116 in FIG. 2. The long term multiplier of the fuel injectors 26 is a trim or adjustment value that the processing unit 32 applies to the control signal to the fuel injectors 26, to adjust the amount of fuel injected by the fuel injectors 26 to the combustion chamber for changing engine conditions. The multiplier threshold is a value of the long term multiplier that is indicative of a potential leak in one of the fuel injectors 26. Generally, when the long term multiplier goes below the multiplier threshold, it may be assumed that the processing unit 32 is compensating for a leaky fuel injector 26. Accordingly, if the long term multiplier is equal to or less than the multiplier threshold, a fuel injector 26 may be leaking. In contrast, if the long term multiplier is greater than the multiplier threshold, it may be assumed that the fuel injectors 26 are not leaking, and that the leak is most likely from the fuel rail 24.

When the processing unit 32 determines that the long term multiplier for the fuel injectors 26 is equal to or less than the multiplier threshold, then the processing unit 32 may identify a leak one or more of the fuel injectors 26. A leaking fuel injector 26 is generally indicated by box 118 in FIG. 2. When the processing unit 32 determines that the long term multiplier for the fuel injector 26 is greater than the multiplier threshold, then the processing unit 32 may identify a leak in the fuel rail 24. A leaking fuel rail 24 is generally indicated by box 120 in FIG. 2.

Once the processing unit 32 has identified a possible leak in the fuel rail 24, and/or the fuel injectors 26, the processing unit 32 may calculate a rail/injector leak severity from the after shutdown leak rate. The step of calculating the rail/injector leak severity is generally indicated by box 122 in FIG. 2. The rail/injector leak severity is a measure of the magnitude of the fuel leak from the high pressure fuel delivery system 20. The rail/injector leak severity may be calculated in a suitable manner. For example, the rail/injector leak severity may be calculated from Equation 4 below.

$${LS}_{FRFI} = \frac{{Q}_{shutdown}}{{Q}_{DTC}} \times 100 \% \qquad 4 )$$

Referring to Equation 4, LS_{FRFI} is the rail/injector leak severity, Q_{shutdown} is the after shutdown leak rate, and Q_{DTC} is the minimum leak rate required to set a diagnostic trouble code in the memory 36 of the processing unit 32.

When the rail/injector leak severity is greater than a pre-defined rail/injector limit, the processing unit 32 may issue a notification that the high pressure fuel delivery system 20 may require service, and include in the notification which of the fuel rail 24 or the fuel injectors 26 is believed to be the cause the fuel leak in the high pressure fuel delivery system 20. The step of issuing the notification for a leaking fuel rail 24 and/or fuel injector 26 is generally indicated by box 124 in FIG. 2. The pre-defined rail/injector limit may include a value indicative of a leak requiring correction. Issuing the notification may include a process capable of conveying a message. For example, issuing the notification may include, but is not limited to, lighting a dash display code, sounding a warning signal, recording a diagnostic code bit in the memory 36 of the processing unit 32, contacting a remote third party to schedule maintenance, etc.

The method of diagnosing the high pressure fuel system may also detect a leak in the high pressure fuel pump 22. In order to do so, a cranking fuel pressure in the fuel rail 24 is sensed with the fuel pressure sensor 28. The step of sensing the cranking fuel pressure is generally indicated by box 130 in FIG. 2. The cranking fuel pressure is sensed over a cranking period of time while the internal combustion engine is cranking and not firing. The duration of the cranking period of time may vary. However, the processing unit 32 measures the duration of the cranking period of time and saves this value in the memory 36 of the controller. During the cranking period of time, the internal combustion engine is being rotated with the high pressure fuel pump 22 pressurizing the fuel within the fuel rail 24, but the processing unit 32 is not signaling the fuel injectors 26 to inject fuel into the combustion chambers. During the cranking period of time, the fuel pressure within the fuel rail 24 should increase with each compression stroke of the high pressure fuel pump 22. However, if a leak exists in the high pressure fuel pump 22, the fuel rail 24, or one of the fuel injectors 26, then the actual or measured rate at which the fuel pressure builds in the fuel rail 24 during the cranking period of time will be less than a nominal fuel pressure build rate. The nominal fuel pressure build rate is the rate at which fuel pressure builds or increases within the fuel rail 24 with no leaks in the high pressure fuel delivery system 20 and with the high pressure fuel pump 22 operating at a design or intended capacity.

In addition to the cranking fuel pressure, a fuel temperature of the fuel disposed within the fuel rail 24 may also be sensed during the cranking period of time. The step of sensing the fuel temperature during the cranking period of time is generally indicated by box 132 in FIG. 2. The fuel temperature is sensed with the temperature sensor 30, and may be used by the processing unit 32 to normalize the cranking fuel pressure over the cranking period of time. The step of normalizing the cranking fuel pressure is generally indicated by box 134 in FIG. 2. As noted above, the measured change in the cranking fuel pressure during the cranking period of time may be compared to the nominal fuel pressure build rate. However, the actual temperature of the fuel within the fuel rail 24 may vary from the temperature at which the nominal fuel pressure build rate was calculated. Normalizing the cranking fuel pressure over the cranking period of time compensates for this variation in fuel temperatures. The cranking fuel pressure may be normalized for the current temperature of the fuel within the fuel rail 24 using a suitable process.

The processing unit 32 calculates a cranking leak rate of the high pressure fuel delivery system 20 from the cranking fuel pressure sensed over the cranking period of time. The step of calculating the cranking leak rate is generally indicated by box 136 in FIG. 2. The cranking leak rate is the amount or mass of fuel that leaks from the high pressure fuel delivery system 20 during the cranking period of time. The mass of fuel that leaks from the high pressure fuel delivery system 20 during the cranking period of time may be calculated from Equation 5 below.

$${m}_{leak} = {m}_{i n} - \frac{{m}_{rail}}{B ( p , T )} Δ {p}_{crank} \qquad 5 )$$

Referring to Equation 5 mₗₑₐₖ is the mass of fuel that has leaked from the high pressure fuel delivery system 20 during the cranking period of time, mᵣₐᵢₗ is the mass of fuel disposed within the high pressure fuel delivery system 20 at the beginning of the cranking period of time, B(p,T) is the Bulk Modulus of Elasticity of the fuel, Δp_{crank} is the measured change in the fuel pressure within the fuel rail 24 during the cranking period of time, and mᵢₙ is the mass of the fuel pumped into the fuel rail 24 by the high pressure fuel pump 22 during the cranking period of time.

After the mass of fuel leaked from the high pressure fuel delivery system 20 during the cranking period of time (mₗₑₐₖ) has been calculated, it may be divided by the cranking period of time to calculate the cranking leak rate. As such, the cranking leak rate is provided by Equation 6 below.

$${Q}_{cranking} = \frac{{m}_{leak}}{{t}_{cranking}} \qquad 6 )$$

Referring to Equation 6, Q_{cranking} is the cranking leak rate, mₗₑₐₖ is the mass of fuel that has leaked from the high pressure fuel delivery system 20 during the cranking period of time, and t_{cranking} is the duration of the cranking period of time.

Once the cranking leak rate has been calculated, the processing unit 32 compares the cranking leak rate to a cranking leak threshold. The step of comparing the cranking leak rate to the cranking leak threshold is generally indicated by box 138 in FIG. 2. The cranking leak rate is compared to the cranking leak threshold to determine if the cranking leak rate is equal to or less than the cranking leak threshold, or if the cranking leak rate is greater than the cranking leak threshold. The cranking leak threshold is a value for a change in fuel pressure during engine cranking prior to firing that is indicative of a possible leak in the high pressure fuel delivery system 20. The cranking leak threshold may be defined as the nominal fuel pressure build rate, or a value slightly less than the nominal fuel pressure build rate. By defining the cranking leak threshold to include a value slightly less than the nominal fuel pressure build rate, the method allows some variation in the system without indicating a possible leak from one of the components of the high pressure fuel delivery system 20.

When the processing unit 32 determines that the cranking leak rate is equal to or less than the cranking leak threshold, generally indicated at 140, then no additional action is taken, generally indicated by box 142 in FIG. 2. When the processing unit 32 determines that the cranking leak rate is greater than the cranking leak threshold, generally indicated at 144, then the processing unit 32 proceeds to analyze the high pressure fuel delivery system 20 to detect a leak in the high pressure fuel pump 22.

In order to analyze the high pressure fuel delivery system 20 to detect a leak in the high pressure fuel pump 22, the processing unit 32 determines if the fuel rail 24 and/or one of the fuel injector 26 is leaking, or if both the fuel rail 24 and the fuel injectors 26 are not leaking. The step of determining if the fuel rail 24 and/or fuel injectors 26 are leaking is generally indicated by box 146 in FIG. 2. The processing unit 32 may follow the process described above to using the after shutdown fuel pressure to determine if either the fuel rail 24 or the fuel injectors 26 are leaking, or if neither the fuel rail 24 nor the fuel injectors 26 are leaking. Briefly, if the shutdown leak rate is greater than the shutdown leak threshold, generally indicated at 114, then one or both of the fuel rail 24 and the fuel injectors 26 are leaking, whereas if the shutdown leak rate is equal to or less than the shutdown leak threshold, generally indicated at 110, then both the fuel rail 24 and the fuel injectors 26 are not leaking.

The processing unit 32 may identify a leak or inefficiency in the high pressure fuel pump 22 when the cranking leak rate is greater than the cranking leak threshold, generally indicated at 144, and both the fuel rail 24 and the fuel injectors 26 are not leaking, generally indicated at 148. The step of identifying a leak or inefficiency in the high pressure fuel pump 22 is generally indicated by box 150 in FIG. 2. If the cranking leak rate is greater than the cranking leak threshold, and if the processing unit 32 has determined that both the fuel rail 24 and the fuel injectors 26 are not leaking, then the leak is most likely from the high pressure fuel pump 22.

If the processing unit 32 has determined that the cranking leak rate is greater than the cranking leak threshold, generally indicated at 144, and that one or both of the fuel rail 24 and/or the fuel injectors 26 are leaking, generally indicated at 152, then the processing unit 32 may compare the cranking leak rate to the after shutdown leak rate to determine if the cranking leak rate is equal to the after shutdown leak rate. The step of determining if the cranking leak rate is equal to the after shutdown leak rate is generally indicated by box 154 in FIG. 2.

When the processing unit 32 determines that the cranking leak rate is equal to the after shutdown leak rate, generally indicated at 156, then the processing unit 32 may issue a notification that the fuel rail 24 and/or the fuel injectors 26 are leaking. The step of issuing the notification that the fuel rail 24 and/or the fuel injectors 26 are leaking is generally indicated by box 158 in FIG. 2.

When the processing unit 32 determines that the cranking leak rate is not equal to the after shutdown leak rate, generally indicated at 160, then the processing unit 32 compares the cranking leak rate to the after shutdown leak rate to determine if the cranking leak rate is greater than the after shutdown leak rate, or if the cranking leak rate is less than the after shutdown leak rate. The step of determining if the cranking leak rate is greater than or less than the after shutdown leak rate is generally indicated by box 162 in FIG. 2.

When the processing unit 32 determines that the cranking leak rate is less than the after shutdown leak rate, generally indicated at 164, then the processing unit 32 may identify an unknown failure mode. The step of identifying the unknown failure mode is generally indicated by box 166 in FIG. 2. When the processing unit 32 determines that the cranking leak rate is greater than the after shutdown leak rate, generally indicated at 168, then the processing unit 32 may identify a leak or inefficiency in the high pressure fuel pump 22. The step of identifying a leak or inefficiency in the high pressure fuel pump 22 is generally indicated by box 150 in FIG. 2.

Once the processing unit 32 has identified a possible leak in the high pressure fuel pump 22, the processing unit 32 may calculate a pump leak severity from the cranking leak rate. The step of calculating the pump leak severity is generally indicated by box 170 in FIG. 2. The pump leak severity is a measure of the magnitude of the fuel leak from the high pressure fuel delivery system 20. The pump leak severity may be calculated in a suitable manner. For example, the pump leak severity may be calculated from Equation 7 below.

$${LS}_{Pump} = \frac{{Q}_{cranking}}{{Q}_{DTC}} \times 100 \% \qquad 4 )$$

Referring to Equation 7, LS_{Pump} is the pump leak severity, Q_{cranking} is the cranking leak rate, and Q_{DTC} is the minimum leak rate required to set a diagnostic trouble code in the memory 36 of the processing unit 32.

When the pump leak severity is greater than a pre-defined pump limit, the processing unit 32 may issue a notification that the high pressure fuel delivery system 20 may require service, and include in the notification which of the high pressure fuel pump 22 is believed to the cause the fuel leak in the high pressure fuel delivery system 20. The step of issuing the notification of the leak in the high pressure fuel pump 22 is generally indicated by box 172 in FIG. 2. The pre-defined pump limit may include a value indicative of a leak requiring correction. Issuing the notification may include a process capable of conveying a message. For example, issuing the notification may include, but is not limited to, lighting a dash display code, sounding a warning signal, recording a diagnostic code bit in the memory 36 of the processing unit 32, contacting a remote third party to schedule maintenance, etc.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A method of diagnosing a high pressure fuel delivery system of an internal combustion engine, the high pressure fuel delivery system including a high pressure pump, a fuel rail, and a fuel injector, the method comprising:
sensing an after shutdown fuel pressure in the fuel rail with a fuel pressure sensor, wherein the after shutdown fuel pressure is sensed over a shutdown period of time when a rotational speed of the internal combustion engine is approximately equal to zero;
calculating an after shutdown leak rate of the high pressure fuel delivery system from the after shutdown fuel pressure sensed over the shutdown period of time, with a processing unit;
comparing the after shutdown leak rate to a shutdown leak threshold, with the processing unit, to determine if the after shutdown leak rate is equal to or less than the shutdown leak threshold, or if the after shutdown leak rate is greater than the shutdown leak threshold;
analyzing the high pressure fuel delivery system, with the processing unit, to detect a leak in one of the fuel rail or the fuel injector, when the after shutdown leak rate is greater than the shutdown leak threshold;
sensing a cranking fuel pressure in the fuel rail with the fuel pressure sensor, wherein the cranking fuel pressure is sensed over a cranking period of time while the internal combustion engine is cranking and not firing;
calculating a cranking leak rate of the high pressure fuel delivery system from the cranking fuel pressure sensed over the cranking period of time, with the processing unit;
comparing the cranking leak rate to a cranking leak threshold, with the processing unit, to determine if the cranking leak rate is equal to or less than the cranking leak threshold, or if the cranking leak rate is greater than the cranking leak threshold; and
analyzing the high pressure fuel delivery system, with the processing unit, to detect a leak in the high pressure fuel pump, when the cranking leak rate is greater than the cranking leak threshold.

2. The method set forth in claim 1, wherein analyzing the high pressure fuel delivery system to detect a leak in one of the fuel rail or the fuel injector includes comparing a long term multiplier for the fuel injector to a multiplier threshold to determine if the long term multiplier for the fuel injector is greater than the multiplier threshold, or if the long term multiplier is equal to or less than the multiplier threshold.

3. The method set forth in claim 2, further comprising identifying a leak in the fuel rail when the long term multiplier for the fuel injector is greater than the multiplier threshold.

4. The method set forth in claim 2, further comprising identifying a leak in the fuel injector when the long term multiplier for the fuel injector is equal to or less than the multiplier threshold.

5. The method set forth in claim 1 further comprising calculating a rail/injector leak severity from the after shutdown leak rate, with the processing unit, when a leak from one of the fuel rail or the fuel injector is identified.

6. The method set forth in claim 5, further comprising issuing a notification, with the processing unit, when the rail/injector leak severity is greater than a pre-defined rail/injector limit.

7. The method set forth in claim 1, further comprising normalizing the after shutdown fuel pressure over the shutdown period of time based on a fuel temp in the fuel rail during the shutdown period of time, and normalizing the cranking fuel pressure over the cranking period of time based on the fuel temperature in the fuel rail during the cranking period of time.

8. The method set forth in claim 1, wherein analyzing the high pressure fuel delivery system to detect a leak in the high pressure fuel pump includes determining if one of the fuel rail or the fuel injector are leaking, or if both the fuel rail and the fuel injector are not leaking.

9. The method set forth in claim 8, wherein analyzing the high pressure fuel delivery system to detect a leak in the high pressure fuel pump includes identifying a leak in the high pressure fuel pump when both the fuel rail and the fuel injector are not leaking, and the cranking leak rate is greater than the cranking leak threshold.

10. The method set forth in claim 9, wherein analyzing the high pressure fuel delivery system to detect a leak in the high pressure fuel pump includes comparing the cranking leak rate to the after shutdown leak rate to determine if the cranking leak rate is equal to the after shutdown leak rate, if the cranking leak rate is less than the after shutdown leak rate, or if the cranking leak rate is greater than the after shutdown leak rate.

11. The method set forth in claim 10, further comprising issuing a notification, with the processing unit, that the one of the fuel rail or the fuel injector is leaking, when the cranking leak rate is equal to the after shutdown leak rate.

12. The method set forth in claim 10, further comprising identifying a leak in the high pressure fuel pump, when the cranking leak rate is greater than the after shutdown leak rate.

13. The method set forth in claim 10, further comprising identifying an unknown failure mode when the cranking leak rate is less than the after shutdown leak rate.

14. The method set forth in claim 1, further comprising calculating a pump leak severity from the cranking leak rate, with the processing unit, when a leak from the high pressure fuel pump is identified.

15. The method set forth in claim 14, further comprising issuing a notification, with the processing unit, when the pump leak severity is greater than a pre-defined pump limit.

16. A method of diagnosing a high pressure fuel delivery system of an internal combustion engine, the high pressure fuel delivery system including a high pressure pump, a fuel rail, and a fuel injector, the method comprising:
sensing an after shutdown fuel pressure in the fuel rail with a fuel pressure sensor, wherein the after shutdown fuel pressure is sensed over a shutdown period of time when a rotational speed of the internal combustion engine is approximately equal to zero;
sensing a fuel temperature in the fuel rail during the shutdown period of time, with a temperature sensor;
normalizing the after shutdown fuel pressure over the shutdown period of time based on the fuel temp in the fuel rail during the shutdown period of time;
calculating an after shutdown leak rate of the high pressure fuel delivery system from the after shutdown fuel pressure sensed over the shutdown period of time;
comparing the after shutdown leak rate to a shutdown leak threshold to determine if the after shutdown leak rate is equal to or less than the shutdown leak threshold, or if the after shutdown leak rate is greater than the shutdown leak threshold;
comparing a long term multiplier for the fuel injector to a multiplier threshold to determine if the long term multiplier for the fuel injector is greater than the multiplier threshold, or if the long term multiplier is equal to or less than the multiplier threshold;
identifying a leak in the fuel rail when the after shutdown leak rate is greater than the shutdown leak threshold and the long term multiplier for the fuel injector is equal to or greater than the multiplier threshold; and
identifying a leak in the fuel injector when the after shutdown leak rate is greater than the shutdown leak threshold and the long term multiplier for the fuel injector is less than the multiplier threshold.

17. The method set forth in claim 16 further comprising calculating a rail/injector leak severity from the after shutdown leak rate, with the processing unit, when a leak from one of the fuel rail or the fuel injector is identified, and issuing a notification, with the processing unit, when the rail/injector leak severity is greater than a pre-defined rail/injector limit.

18. A method of diagnosing a high pressure fuel delivery system of an internal combustion engine, the high pressure fuel delivery system including a high pressure pump, a fuel rail, and a fuel injector, the method comprising:
sensing a cranking fuel pressure in the fuel rail with a fuel pressure sensor, wherein the cranking fuel pressure is sensed over a cranking period of time while the internal combustion engine is cranking and not firing;
sensing a fuel temperature in the fuel rail during the cranking period of time, with a temperature sensor;
normalizing the cranking fuel pressure over the cranking period of time based on the fuel temp in the fuel rail during the cranking period of time;
calculating a cranking leak rate of the high pressure fuel delivery system from the cranking fuel pressure sensed over the cranking period of time;
comparing the cranking leak rate to a cranking leak threshold to determine if the cranking leak rate is equal to or less than the cranking leak threshold, or if the cranking leak rate is greater than the cranking leak threshold;
determining if one of the fuel rail or the fuel injector is leaking, or if both the fuel rail and the fuel injector are not leaking; and
identifying a leak in the high pressure fuel pump when both the fuel rail and the fuel injector are not leaking, and the cranking leak rate is greater than the cranking leak threshold.

19. The method set forth in claim 18, further comprising:
comparing the cranking leak rate to an after shutdown leak rate, with the processing unit, to determine if the cranking leak rate is equal to the after shutdown leak rate, if the cranking leak rate is less than the after shutdown leak rate, or if the cranking leak rate is greater than the after shutdown leak rate;
issuing a notification, with the processing unit, that one of the fuel rail or the fuel injector is leaking, when the cranking leak rate is equal to the after shutdown leak rate;
identifying a leak in the high pressure fuel pump, when the cranking leak rate is greater than the after shutdown leak rate; and
identifying an unknown failure mode when the cranking leak rate is less than the after shutdown leak rate.

20. The method set forth in claim 19, further comprising calculating a pump leak severity from the cranking leak rate, with the processing unit, when a leak from the high pressure fuel pump is identified, and issuing a notification, with the processing unit, when the pump leak severity is greater than a pre-defined pump limit.
